(19) United States
(12) Patent Application Publication
(10) Pub. No.: US 2025/0174800 A1
(43) Pub. Date: May 29, 2025

(54) Battery Power Pack System for Electric Vehicles

(71) Applicant: Ogbebor Amadin, Citrus Heights, CA (US)

(72) Inventor: Ogbebor Amadin, Citrus Heights, CA (US)

(21) Appl. No.: 18/518,991

(22) Filed: Nov. 26, 2023

(51) Int. Cl. H01M 50/249; B60L 50/64; B60L 53/80; B60L 58/20; H01M 50/209; H01M 50/262

(52) U.S. Cl. CPC H01M 50/249; B60L 50/64; B60L 53/80; B60L 58/20; H01M 50/209; H01M 50/262; H01M 2220/20

(57) ABSTRACT

The present invention discloses a battery power pack system for electric vehicles, comprising a combination of a fixed battery and interchangeable auxiliary battery modules, thus enhancing the range and adaptability of electric vehicles. Each auxiliary battery module operates independently, amplifying the energy capacity of the fixed battery and enabling longer driving distances. The battery power pack system further comprises a battery pack case 1, battery modules 2, a permanent battery 3, a bay or compartment door 4 for battery module 5, and battery module illustration of exchange or swapping 6. The battery configuration is designed to divide the battery case into three sections, namely one designated for the fixed battery and two for the auxiliary battery modules. This system employs a user-friendly bay door mechanism for quick and efficient module installation and removal.

### TECHNICAL FIELD

The present invention relates to electric vehicles, specifically to a battery power pack system for electric vehicles in which each auxiliary battery module operates to, amplifying the energy capacity of the fixed battery and enabling longer driving distances.

### BACKGROUND ART

A battery pack is a device that stores electrical energy to provide power to an electrical system, such as an electric vehicle (EV) or an energy storage system (ESS). The energy is stored in cells that are all connected to one another in the battery pack.

Battery packs are made of multiple, smaller sections called battery modules (or sub packs). These modules include a smaller number of cells connected in series and parallel. They are usually at a lower voltage, which is safe for handling. Modules facilitate servicing when only a few cells are defective and if they can be replaced without replacing the entire battery. EV batteries are typically made of 4 to 40 modules connected in series to one another.

One of the main challenges are the cell voltages, which drift apart because of manufacturing tolerances and aging. Therefore, to extend the battery lifetime, a BMS needs to do a good balancing between the cells, to recover bad ones and save good ones.

The US patent application published as U.S. Pat. No. 10,195,929B2 in 2019 discloses an electrically-driven vehicle that includes a high-capacity battery unit and a high-output battery unit, both of which supply electric power to rotating electric machines, and a charging inlet serving as a charging port of an external power supply.

The high-capacity battery unit receives more charge power from the charging inlet than the high-output battery unit and is positioned nearer to the charging inlet than the high-output battery unit is to the charging inlet. In this way, an electric power loss increase caused by a wiring resistance during an external charge can be suppressed in a plug-in type electrically-driven vehicle, which is chargeable by an external power supply.

There is need to develop a battery power pack system for electric vehicles having a combination of a fixed battery and interchangeable auxiliary battery modules.

### OBJECTS OF THE INVENTION

The main object of the present invention is to provide a battery power pack system for electric vehicles as a groundbreaking innovation poised to revolutionize the electric vehicle industry.

The other object is to design an electric vehicle accessory encompassing fixed and interchangeable battery modules to provide a solution to range limitations and facilitates cost-effective and sustainable electric mobility.

The following summary is an explanation of some of the general inventive steps for the system, method, architecture and container in the description.

This summary is not an extensive overview of the invention and does not intend to limit the scope beyond what is described and claimed as a summary.

### SUMMARY OF THE INVENTION

The present invention describes a unique a battery power pack system for electric vehicles. The system comprising a combination of a fixed battery and interchangeable auxiliary battery modules, thus enhancing the range and adaptability of electric vehicles.

Each auxiliary battery module operates independently, amplifying the energy capacity of the fixed battery and enabling longer driving distances.

This system employs a user-friendly bay door mechanism for quick and efficient module installation and removal.

### BRIEF DESCRIPTION OF THE DRAWING

The novel features believed to be characteristic of the illustrative embodiments are outlined in the appended claims. The illustrative embodiments, however, as well as a preferred mode of use, further objectives, and descriptions thereof, will best be understood by reference to the following detailed description of one or more illustrative embodiments of the present disclosure when read in conjunction with the accompanying drawings.

The accompanied figures represent the device representation of a battery power pack system for electric vehicles:

FIG. 1 is a representation of a battery power pack system for electric vehicles having a combination of a fixed battery and interchangeable auxiliary battery modules as described in the present invention.

FIG. 2 is the battery power pack system for electric vehicles with the batteries separated from the case.

FIG. 3a is the battery power pack system for electric vehicles and power pack case.

FIG. 3b is a battery power pack case for the electric vehicles battery swapping

FIG. 4 is the battery power pack without the case for electric vehicles showing the permanent and auxiliary modules of the system.

FIG. 5 is the battery module for a battery power pack system for electric vehicles.

### DESCRIPTION OF THE INVENTION

In the following detailed description of the invention, numerous details, examples, and embodiments of the invention are described. However, it will be clear and apparent to those knowledgeable in the field that the invention is not limited to the embodiments set forth and that the invention can be adapted for a wider range of applications.

In a more detailed disclosure, the present invention describes a unique electric vehicles battery swapping system designed for electric vehicles. It comprises a combination of a fixed battery and interchangeable auxiliary battery modules, thus enhancing the range and adaptability of electric vehicles. Each auxiliary battery module operates independently, amplifying the energy capacity of the fixed battery and enabling longer driving distances. This system employs a user-friendly bay door mechanism for quick and efficient module installation and removal.

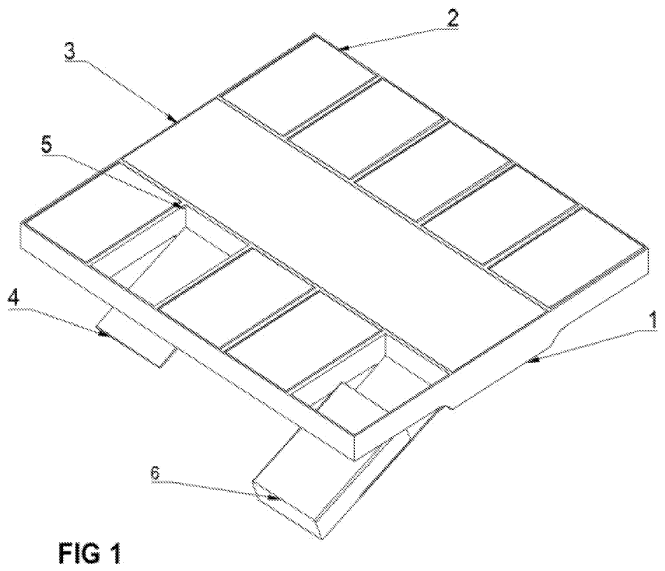

In a more general embodiment according to FIG. 1, the invention presents a battery power pack system for electric vehicles in which each auxiliary battery module operates to amplifying the energy capacity of the fixed battery and enabling longer driving distances.

The system has a battery pack case 1, battery modules 2, a permanent battery 3, a bay or compartment door 4 for battery module 5, and battery module illustration of exchange or swapping 6.

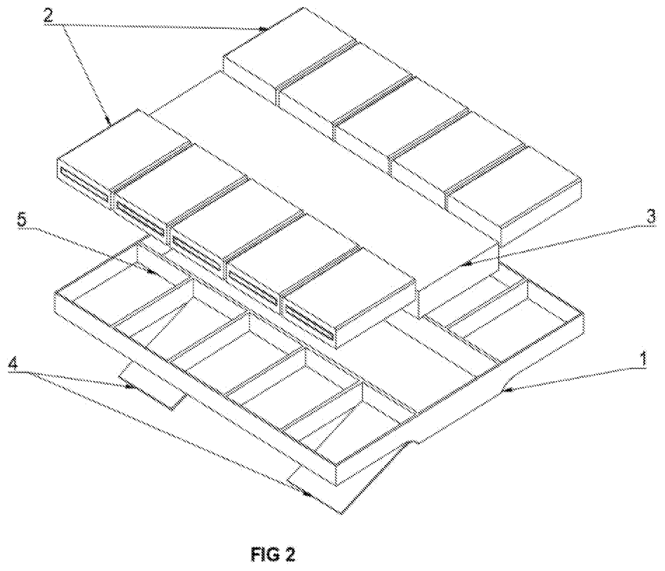

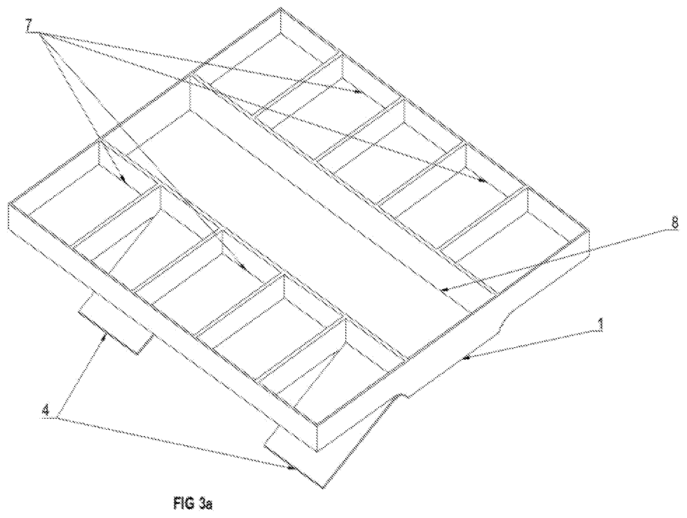

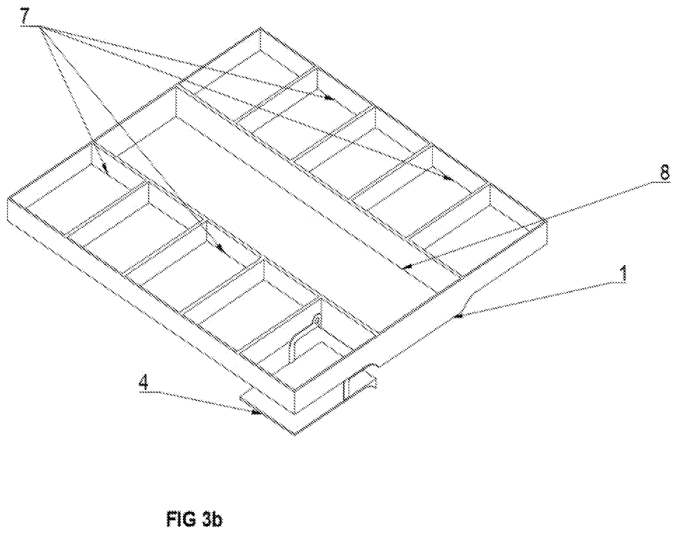

In FIG. 2 the invention illustrates the battery pack case 1, battery modules 2, and bay or compartment door 4, battery bay 5. FIG. 3a illustrates the permanent battery bay 8, the auxiliary battery bays 7, and bays door or lids 4.

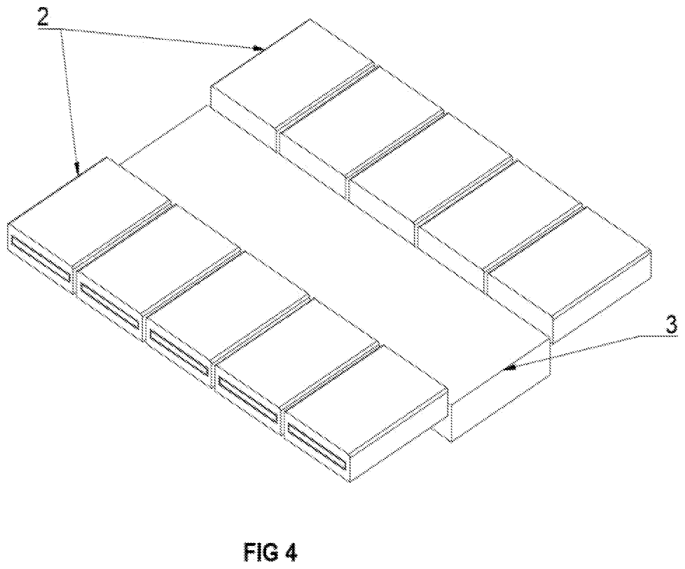

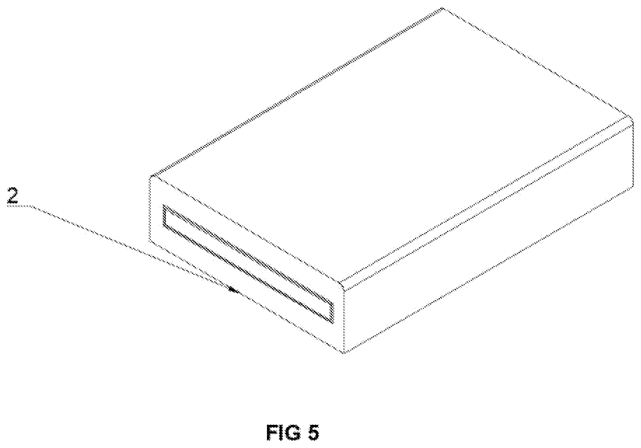

In FIG. 3b, the invention illustrates the battery pack case 1, the permanent battery 8, auxiliary battery bays 7, and bay door or lid 4. In FIG. 4, the invention illustrates the permanent battery 3 and the permanent and auxiliary modules 2. In FIG. 5, the invention illustrates the permanent and auxiliary modules 2 of the present invention.

### Battery Configuration

The invention divides the battery case 1 into three sections: one designated for the fixed battery and two of the permanent and auxiliary modules 2. A bay door 4, featuring a secure latch, is located at the base of the battery pack case 1. This door's primary function is to provide access for the installation and removal of auxiliary battery modules 2.

### Boosting Mechanism

The primary innovation lies in the concept of a fixed battery system paired with removable auxiliary battery modules 2. The auxiliary batteries act as supplementary power sources for the fixed battery, thereby extending the driving range of electric vehicles. The bay doors 4 facilitate easy access to these auxiliary modules 2.

### Utility and Purpose

The invention significantly enhances electric vehicle utility by enabling owners to operate their vehicles with smaller fixed batteries for daily driving, reserving auxiliary modules 2 for longer journeys.

This approach reduces resource consumption and production costs associated with large battery packs. It also paves the way for battery exchange and booster stations, offering environmental benefits and cost savings.

### Environmental Impact

The adoption of this battery swappable platform technology has the potential to democratize electric vehicles by making them more affordable and competitive with internal combustion vehicles. The subsequent reduction in carbon emissions aligns with environmental preservation and the fight against global warming.

### Job Creation

In recognition of the potential job displacement resulting from a shift to electric vehicles, this invention is designed to create jobs through the establishment of battery exchange, swap, and booster stations, mirroring the ecosystem of traditional fueling stations.

While the invention has been described with reference to numerous specific sensors, one of ordinary knowledge in the field will recognize that the invention can be embodied in other specific forms without departing from the spirit of the invention. Specific operations may not be performed in one continuous series of operations, and different specific operations may be performed in different embodiments.

Furthermore, the processes or methods could be implemented using several sub-processes, or as part of a larger macro process. Thus, one of ordinary knowledge in the field would understand that the invention is not to be limited by the foregoing illustrative details, but rather is to be defined by the appended claims.

### INDUSTRIAL APPLICATION

The present invention applies to electric vehicles. It introduces a battery power pack system as a groundbreaking innovation poised to revolutionize the electric vehicle industry. The design, encompassing fixed and interchangeable battery modules, serves as a solution to range limitations and facilitates cost-effective and sustainable electric mobility.

What is claimed is:

1. A battery power pack system for electric vehicles, comprising;
a battery pack case;
battery modules;
a permanent battery;
a bay or compartment door for battery module, and
a battery module bay.

2. The battery power pack swapping system according to claim 1, wherein the battery configuration is designed to divide the battery case into three sections, namely;
one designated for the fixed battery, and
two for the auxiliary battery modules.

3. The battery power pack swapping system according to claim 2, wherein fixed battery module for charging electric vehicles.

4. The battery power pack system according to claim 2, wherein the interchangeable auxiliary battery modules designed for enhancing the range and adaptability of electric vehicles.

5. The battery power pack system according to claim 4, wherein each auxiliary battery module operates by amplifying the energy capacity of the fixed battery and enabling longer driving distances.

6. The battery power pack system according to claim 1, wherein the bay door further comprises a secure latch located at the base of the battery pack case.

7. The electric vehicles battery swapping system according to claim 6, wherein the door's primary function is to provide access for the installation and removal of auxiliary battery modules.

8. The battery power pack system according to claim 3, wherein the fixed battery system is paired with removable auxiliary battery modules as boosting mechanism.

9. The battery power pack system according to claim 8, wherein the auxiliary batteries act as supplementary power sources for the fixed battery, thereby extending the driving range of electric vehicles.

10. The battery power pack system according to claim 9, wherein the bay doors are designed to facilitate easy access to these auxiliary modules.

11. The battery power pack system according to claim 10, wherein the system is meant to enhance electric vehicle utility by enabling owners to operate their vehicles with smaller fixed batteries for daily driving, reserving auxiliary modules for longer journeys.

12. The battery power pack system according to claim 11, wherein the system is designed to:
a reduce resource consumption and production costs associated with large battery packs, and
pave the way for battery exchange and booster stations, offering environmental benefits and cost savings.

13. The battery power pack system according to claim 11, wherein the adoption of said battery swappable platform technology further comprises the potential to:
democratize electric vehicles by making them more affordable and competitive with internal combustion vehicles, and
subsequent reduction in carbon emissions aligns with environmental preservation and the fight against global warming.
